(19) United States
(12) Patent Application Publication
(10) Pub. No.: US 2007/0291749 A1
(43) Pub. Date: Dec. 20, 2007

(54) Information processing apparatus, line release method for information processing apparatus, and computer product

(75) Inventor: Yoshihiko Taki, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 11/892,646

(22) Filed: Aug. 24, 2007

Related U.S. Application Data
(63) Continuation of application No. PCT/JP05/03040, filed on Feb. 24, 2005.

(51) Int. Cl. H04L 12/66

(52) U.S. Cl. 370/356

(57) ABSTRACT

An information processing apparatus is configured to be connected to a network system in which line connection is established using point-to-point protocol, and charge is based on a period from establishment to release of the line connection. The information processing apparatus includes an input monitoring unit that monitors line-release operation input and completion of packet transmission/reception, and a communication control unit that releases the line connection when at least one of the line-release operation input and completion of packet transmission/reception is detected.

### BACKGROUND OF THE INVENTION

1. Field of the Invention

The present invention generally relates to an information processing apparatus, a line-release method for the information processing apparatus, and a computer product.

2. Description of the Related Art

A PPP has been used as a protocol for connecting an information processing apparatus to a network via a line such as a telephone line. The PPP is a protocol for connecting two points, that is, a remote communication station and a user. The PPP works at a data link layer, and is capable of authentication or compression. At a network layer or higher layers, it is possible to use various protocols such as a TCP/IP and an IPX/SPX. The PPP is used for personal computer communications or Internet accesses. For example, when the user intends to perform the personal computer communications or connect to the Internet, the PPP is used for connecting the user to the communication station such as a web server via, for example, a dial-up connection. A charging system employed by such a network system using the PPP as a protocol is often a packet-based charging system in which a communication fee is charged depending on an amount of communicated data (packets). Reference may be had to, for example, Japanese Patent Application Laid-open No. H10-42271.

However, it is expected that, for the network system using the PPP as a protocol, a time-based charging system appears in a course of full transition to a flat-rate system in the near future. The flat-rate system indicates the system that constantly charges a flat-rate usage fee regardless of an amount of communicated packets or a connection period of the line. The time-based system indicates the system that charges based on a connection period of the line regardless of an amount of communicated packets.

However, the time-based system can cause the following problem, for example, while a user is browsing a Web page (home page) by the information processing apparatus after accessing the Web server. That is, while the once-displayed (downloaded) home page is being browsed, even though a communicated data amount (amount of packets) is zero, the usage fee is charged as long as the line is connected (the PPP link is being established), unless the user voluntarily provides line-release operation input.

Such a problem can be avoided if the user voluntarily provides the line-release operation input to release the line. However, it is troublesome for the user to provide the line-release operation input frequently. In some cases, for example, when the user enters an area with a poor radio wave condition such as in a tunnel while the PPP link is kept established, it can be impossible to release the line normally, even though the user tries to release the line voluntarily. In such cases, a fee is charged even for the period of the line being unused.

### SUMMARY OF THE INVENTION

It is an object of the present invention to at least partially solve the problems in the conventional technology.

According to an aspect of the present invention, an information processing apparatus configured to be connected to a network system via a line, includes a monitoring unit that monitors whether at least one of a line-release signal and a completion signal is received, a line-release signal requesting release of an established line, and a completion signal indicating completion of packet exchange, and a communication control unit that releases the line when at least one of the line-release signal and the completion signal is received.

According to another aspect of the present invention, a line-release method for an information processing apparatus configured to be connected to a network system via a line, includes monitoring whether at least one of a line-release signal and a completion signal is received, a line-release signal requesting release of an established line, and a completion signal indicating completion of packet exchange, and releasing the line upon receipt of at least one of the line-release signal and the completion signal.

According to still another aspect of the present invention, a computer-readable recording medium stores therein a computer program that implements the above method on a computer.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a diagram of an information processing apparatus according to a first embodiment of the present invention;

FIG. 2 is a functional block diagram of a mobile terminal device as the information processing apparatus shown in FIG. 1;

FIG. 3 is a flowchart of the operation of a transmission/reception signal managing unit shown in FIG. 2 upon receiving a packet transmission/reception completion signal, and a sequence chart of TCP control-signal exchange between the mobile terminal device and a Web server when the packet transmission/reception completion signal is received;

FIG. 4 is a diagram of a relation between three modes and three selectors on the line release operation performed by the mobile terminal device shown in FIG. 2;

FIG. 5 is a flowchart of the operation of an operation input monitoring unit shown in FIG. 2;

FIG. 6 is a flowchart of the operation of a communication control unit shown in FIG. 2 when such a signal is received that triggers transmission of a line-release request to a PPP control unit;

FIG. 7 is a functional block diagram of a mobile terminal device according to a second embodiment of the present invention;

FIG. 8 is a flowchart of the operation of a communication control unit shown in FIG. 7 when such a signal is received that triggers transmission of a line-release request to a PPP control unit;

FIG. 9 is a functional block diagram of a mobile terminal device according to a third embodiment of the present invention; and

FIG. 10 is a flowchart of the operation of a communication control unit shown in FIG. 9 when such a signal is received that triggers transmission of a line-release request to a PPP control unit.

### DETAILED DESCRIPTION OF THE PREFERRED EMBODIMENTS

Exemplary embodiments of the present invention are described in details below with reference to the accompanying drawings.

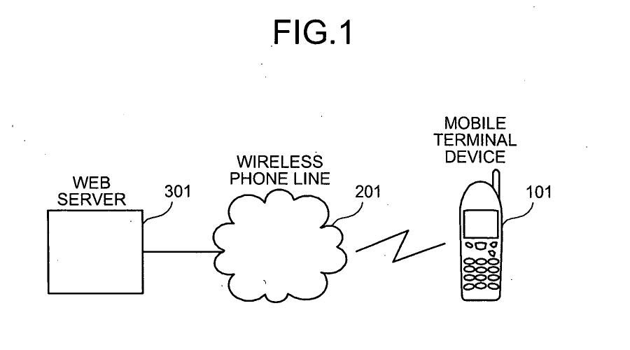

FIG. 1 is a diagram of an information processing apparatus according to a first embodiment of the present invention being connected to a network. The information processing apparatus is, specifically, a mobile terminal device 101 installed with an application used on the Internet, such as a browser and a mailer. The mobile terminal device 101 transmits or receives data by using a TCP (transmission control protocol) at the network layer. Moreover, the mobile terminal device 101 connects to or releases a link of a wireless line by using LCP (link control protocol) at the data link layer. The LCP is a protocol for controlling a link based on the PPP. In the first embodiment, it is assumed that the mobile terminal device 101 is connected to a network system that includes a wireless phone line 201 and a Web server 301 with a time-based charging system.

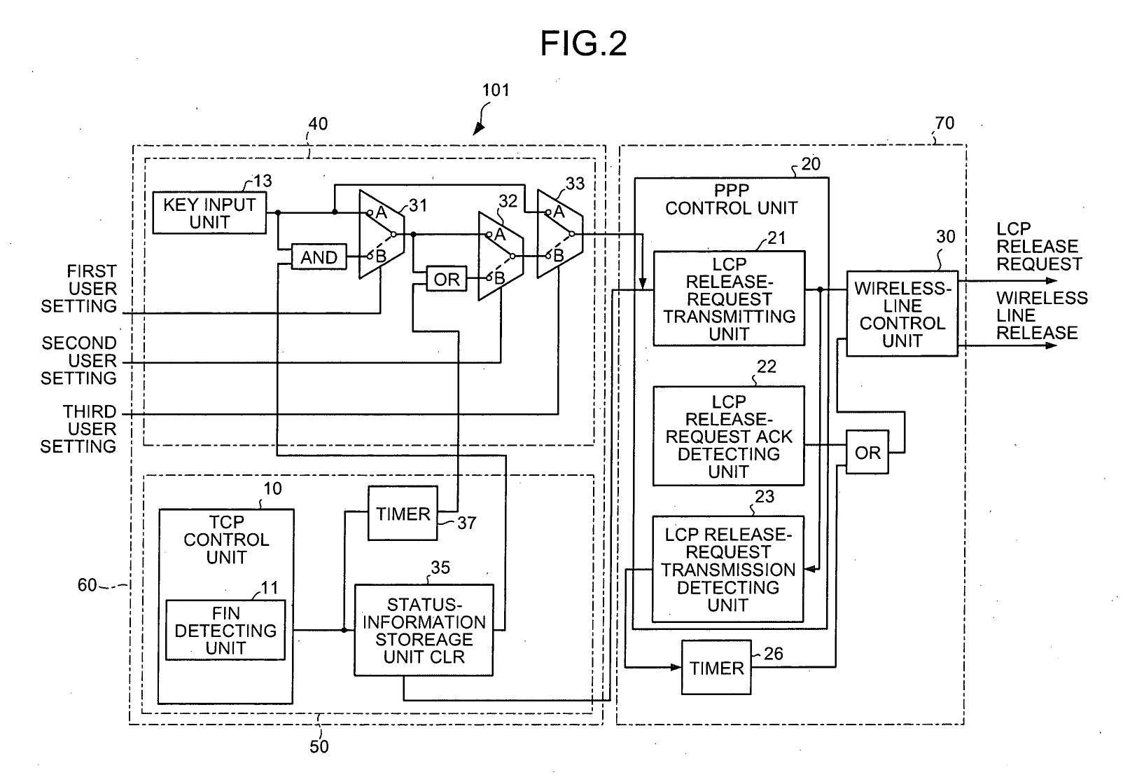

FIG. 2 is a functional block diagram of the mobile terminal device 101. The mobile terminal device 101 includes an input monitoring unit 60 for monitoring an input signal input to the device, and a communication control unit 70 for controlling a communication line on the wireless phone line 201. The input monitoring unit 60 includes an operation input monitoring unit 40 that receives an operation input provided by a user and that monitors the input signal, and a transmission/reception signal managing unit 50 that transmits or receives packet data via the wireless phone line 201 and that monitors the transmitted/received data.

The transmission/reception signal managing unit 50 transmits or receives packet data via the wireless phone line 201 to or from the Web server 301, and includes a TCP control unit 10 that performs TCP control for controlling transmitting or receiving of the packet data. Moreover, the TCP control unit 10 includes a FIN detecting unit 11 that specially detects a packet transmission/reception completion signal (FIN signal) out of the received data from the Web server 301. The transmission/reception signal managing unit 50 additionally includes a status-information storage unit 35 that stores therein information indicative that the FIN signal has been received and a timer 37 as a timer unit that starts counting upon receipt of the FIN signal. The status stored by the status-information storage unit 35 is cleared when new packet data is transmitted or received.

The operation input monitoring unit 40 includes a key input unit 13 that is used by the user to provide a line-release operation input via a not-shown input key, and three selectors of a first, a second, and a third selectors 31, 32, and 33. Each of the three selectors 31, 32, and 33 selects input signal A or B, and outputs the selected signal to a following step. The selection can be switched by a first to a third user settings, those input from outside. The line-release operation input provided through the key input unit 13 is input as one of the input signals to each of the fires selector 31 and the third selector 33. An AND condition signal based on the line-release operation input and output of the status-information storage unit 35 is input to the first selector 31 as the other input signal. An output signal from the first selector 31 is input to the second selector 32 unchanged and an OR condition signal based on the output signal from the first selector 31 and a count-up signal from the timer 37 is also input to the second selector 32. An output of the second selector 32 and the line-release operation input are provided to the third selector 33.

The communication control unit 70 includes a PPP control unit 20 that performs a PPP-link line connecting control and a wireless-line control unit 30 that actually transmits various LCP commands for the line connecting control. The PPP control unit 20 includes an LCP release-request transmitting unit 21 that transmits a line-release request based on the LCP (LCP release request) for releasing a line for which connection established on the PPP link, an LCP release-request ACK detecting unit 22 that detects an LCP release-request ACK, that is, an ACK signal in response to the LCP release request, an LCP release-request transmission detecting unit 23 that detects that the own device has transmitted the LCP release request, and a timer 26 that is activated by the LCP release-request transmission detecting unit 23 triggered by transmission of the LCP release request.

The FIN signal stored in the status-information storage unit 35 and the output signal from the second selector 32 are input to the LCP release-request transmitting unit 21. Upon one of the two signals being input, the LCP release-request transmitting unit 21 transmits the LCP release request to the Web server 301. While being output to outside as described above, the LCP release request is also input to the LCP release-request transmission detecting unit 23 of the own device. The LCP release-request transmission detecting unit 23 detects the input, and activates the timer 26. An OR condition signal based on an ACK detection signal from the LCP release-request ACK detecting unit 22 and the count-up signal from the timer 26 is input to the wireless-line control unit 30. Upon one of the two signals is input, the wireless-line control unit 30 starts a wireless-line release procedure.

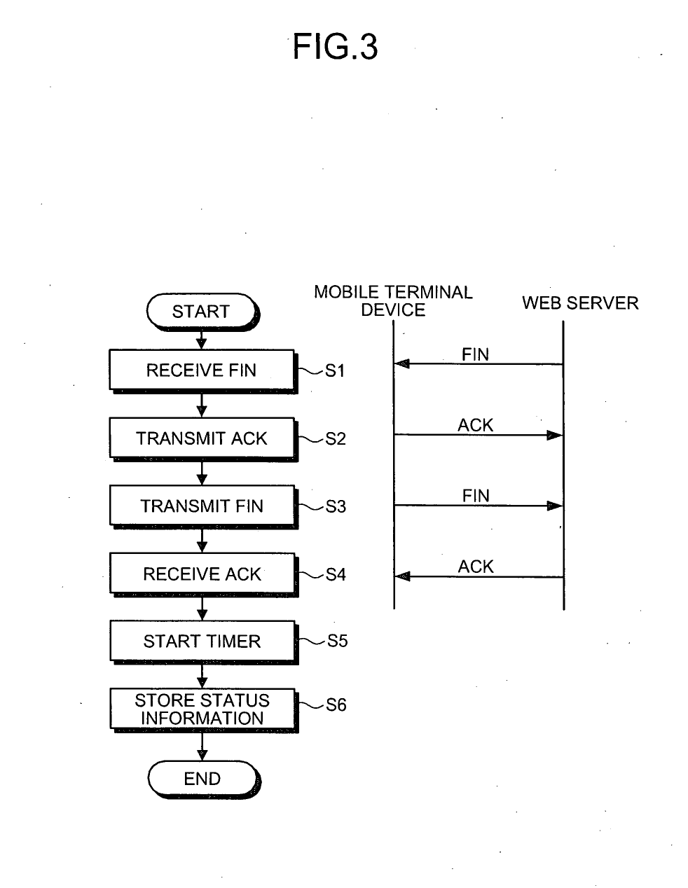

FIG. 3 is a flowchart of the operation of the transmission/reception signal managing unit 50 upon receiving a packet transmission/reception completion signal (FIN signal), and a sequence chart of TCP control-signal exchange between the mobile terminal device 101 and the Web server 301 when the packet transmission/reception completion signal (FIN signal) is received. In the transmission/reception signal managing unit 50, the FIN detecting unit 11 monitors the packet transmission/reception completion signal (FIN signal) transmitted from the Web server 301 via the wireless phone line 201 at all times. When the FIN detecting unit 11 receives the FIN signal (step S1), the TCP control unit 10 transmits, as a response, an ACK signal to the Web server 301 (step S2), and subsequently transmits the FIN signal (step S3). The Web server 301 transmits an ACK signal in response to the FIN signal, and the TCP control unit 10 receives the ACK signal (step S4). After the sequence for receiving a series of the TCP packet transmission/reception completion signals, the TCP control unit 10 causes the timer 37 to start counting (step S5). In addition, a signal indicative that the packet transmission/reception is complete is stored in the status-information storage unit 35 from the Web server 301 (step S6). The stored status is cleared when new packet data is transmitted or received.

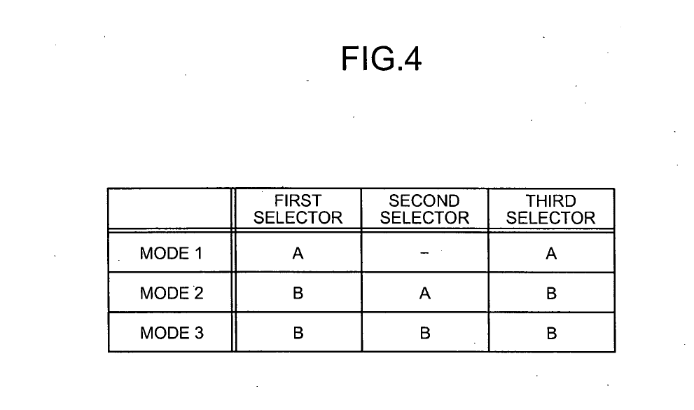

The mobile terminal device 101 includes the first, the second and the third selectors 31, 32, and 33 as mode selecting units, and performs the line-release operation according to one of the following three modes selected by the first to third user settings. A relation between the modes and the first to third selectors 31, 32, and 33 is depicted in FIG. 4. Operations according to Mode 1 to Mode 3 are as follows:

Mode 1: (Where the first selector 31 is set to A side, and the third selector 33 is set to A side) the line is released by the line-release operation input provided by the user. When the settings are selected, the line can be disconnected by the line-release operation input regardless of termination or non-termination of a packet transmitting/receiving.

Mode 2: (Where the first selector 31 is set to B side, the second selector 32 is set to A side, and the third selector 33 is set to B side) if the line-release operation input is provided by the user and the packet transmission/reception completion signal (FIN signal) is detected, the line is released.

Mode 3: (Where the first selector 31 is set to B side, the second selector 32 is set to B side, and the third selector 33 is set to B side) in addition to the operation at Mode 2, if the packet data transmitting/receiving is not performed for a predetermined period, the line is released.

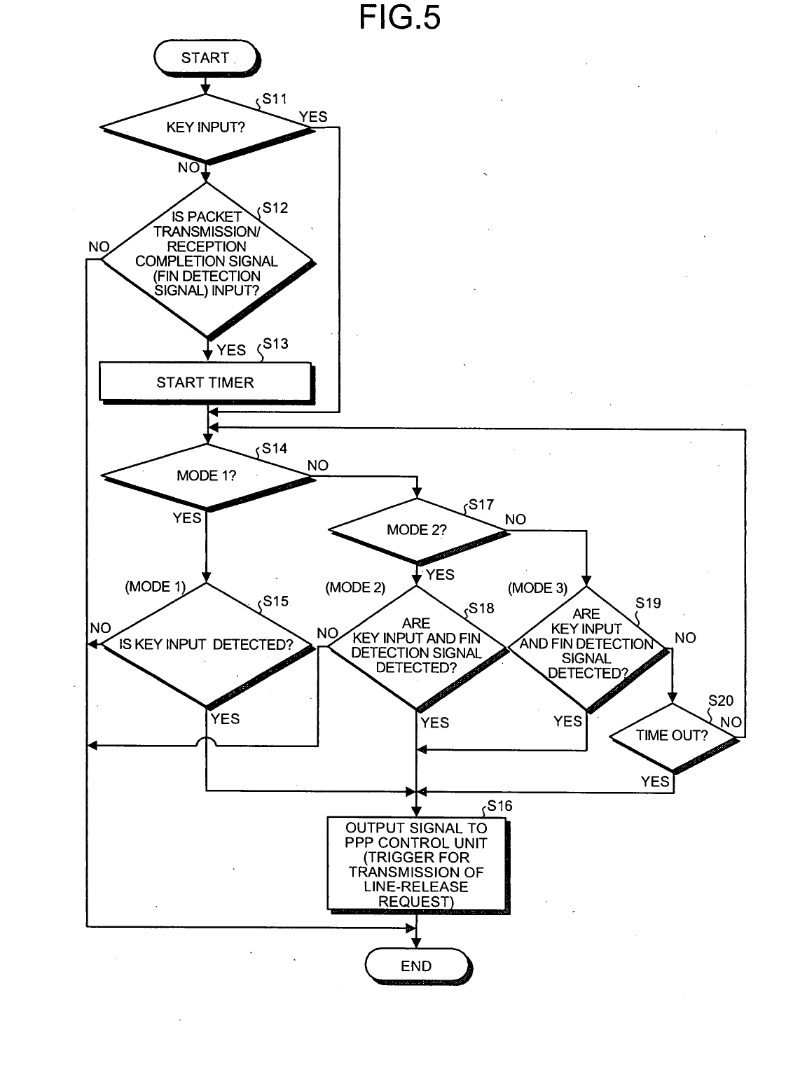

FIG. 5 is a flowchart of the operation of the operation input monitoring unit 40. First, it is determined whether line-release operation input is provided through the key input unit 13 (hereinafter, simply refereed to as “key input”) (step S11). When the key input is provided, the process control jumps to step S14 at which a mode determination is performed. On the other hand, when the key input is not provided, it is determined whether the packet transmission/reception completion signal (FIN signal) is stored in the status-information storage unit 35 (step S12). When the FIN signal is not stored, the process control exits the loop. On the other hand, when the FIN signal is stored in the status-information storage unit 35, the timer 37 starts counting (step S13). Then, the process control goes to the mode determination at step S14.

At the step of the mode determination, it is determined whether Mode 1 is set (step S14). When Mode 1 is set, it is determined whether a condition that key input is provided is satisfied (step S15). When the key input is provided, the process control goes to step S16, and a signal that triggers transmission of the line-release request is output to the communication control unit 70. On the other hand, when Mode 1 is not set at step S14, it is determined whether Mode 2 is set (step S17). When Mode 2 is set, it is determined whether another condition that key input and an FIN signal are detected is satisfied (step S18). When the condition is satisfied, the process control goes to step S16, and the signal that triggers transmission of the line-release request is output to the PPP control unit 20. When Mode 2 is not set at step S17, that is, it is assumed that Mode 3 is set, it is determined at step S19 whether the condition that key input and an FIN signal are detected is satisfied. When the condition is satisfied, the process control goes to step S16, and the signal that triggers transmission of the line-release request is output to the PPP control unit 20. On the other hand, when the condition is not satisfied at step S19, it is determined whether a period counted by the timer 37 reaches a predetermined count value (step S20). When the period reaches the predetermined count value, the process control goes to step S16, and the signal that triggers the transmission of line-release request is output to the PPP control unit 20. When the period does not reach the predetermined count value, the process control returns to step S14.

A computer program (hereinafter, “line-release program”) can be executed to implement the operation of the transmission/reception signal managing unit 50 upon receiving the packet transmission/reception completion signal (FIN signal) as shown in FIG. 3 and the operation of the operation input monitoring unit 40 as shown in FIG. 5. In this case, the line-release program stored in a not-shown recording device such as a memory is executed by a not-shown CPU. Settings on the selectors 31, 32, and 33 can be stored in the recording device such as a memory. If the settings are stored, the mode can be switched by changing the settings on the memory.

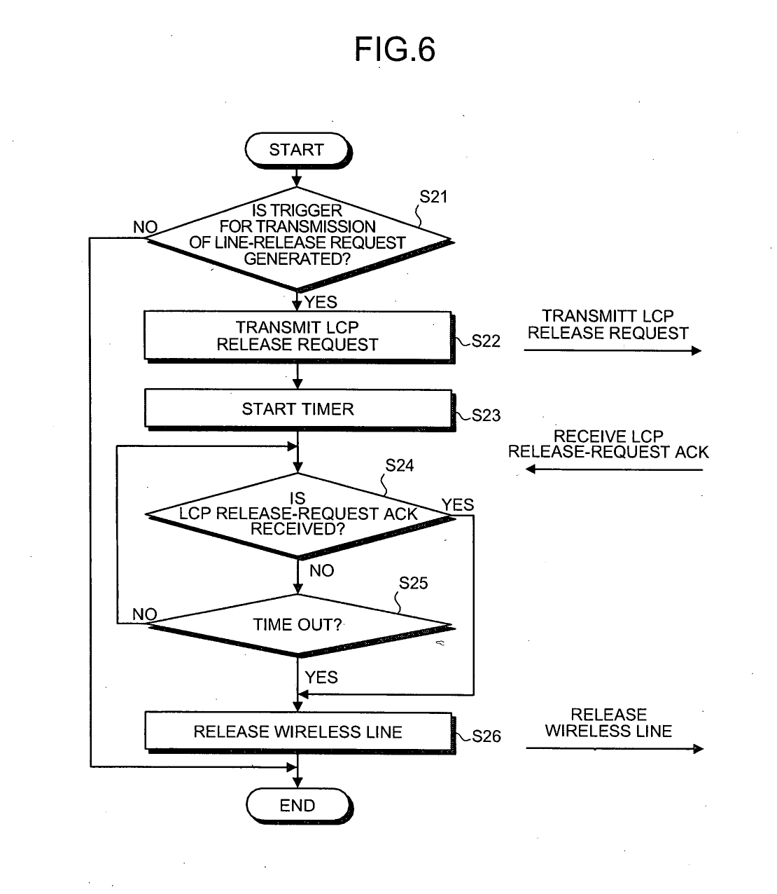

FIG. 6 is a flowchart of the operation of the communication control unit 70 when such a signal is received that triggers transmission of the line-release request to the PPP control unit 20. The LCP release-request transmitting unit 21 determines whether there is any one of an output signal from the second selector 32 and a FIN signal that is in a state stored by the status-information storage unit 35, that is, whether there is the trigger for transmission of the line-release request (step S21). If any, the LCP release-request transmitting unit 21 transmits the LCP release request to the Web server 301 that performs the PPP termination control (step S22). The LCP release-request transmission detecting unit 23 detects the transmission of the LCP release request from its own device, and causes the timer 26 to start counting (step S23).

Upon receiving the LCP release request, the Web server 301 performs the operation of the line release, and returns the LCP release-request ACK as a response. The LCP release-request ACK detecting unit 22 detects the ACK signal (step S24). Upon the PPP control unit 20 receiving the ACK signal, the process control goes to step S26 to start the wireless-line release procedure via the wireless-line control unit 30. On the other hand, the timer 26 determines whether the predetermined period has passed since the transmission of the LCP release request from its own device (step S25). When the LCP release-request ACK is not received within the predetermined period, the wireless-line release procedure is started (step S26).

The trigger for transmitting the line-release request is generated from either the detection of the LCP release by the LCP release-request ACK detecting unit 22 or the count-up signal based on the timer 26 of the LCP release-request transmission detecting unit. This is because, for example, if a radio wave condition of the wireless line is poor, there is a possibility that the LCP release request is not carried to the network (Web server 301) side. Moreover, even though the LCP release request has been carried to the Web server 301, there is a possibility that the mobile terminal device 101 cannot receive the LCP release-request ACK in response to the LCP release request. Even if such an event occurs, it is possible to cause the wireless-line release procedure to start using the operation by the timer 26 without waiting the LCP release-request ACK. A computer program, i.e., a line-release program can be executed to realize the operation of the communication control unit 70 as shown in FIG. 6.

In the mobile terminal device 101 with such a configuration, the input monitoring unit 60 monitors the line-release operation input and the packet transmission/reception completion, and when at least one of the two is detected, generates the trigger. The communication control unit 70 release, when the trigger generates, the wireless line. Therefore, it is possible to highly reliably release the line when the line is unnecessary to be connected, which makes it possible to reduce an unnecessary charge.

Although the information processing apparatus according to the first embodiment is the mobile terminal device 101 configured to be connected to the Web server 301 via the wireless phone line 201, the line is not limited to the wireless line, and can be a wired line.

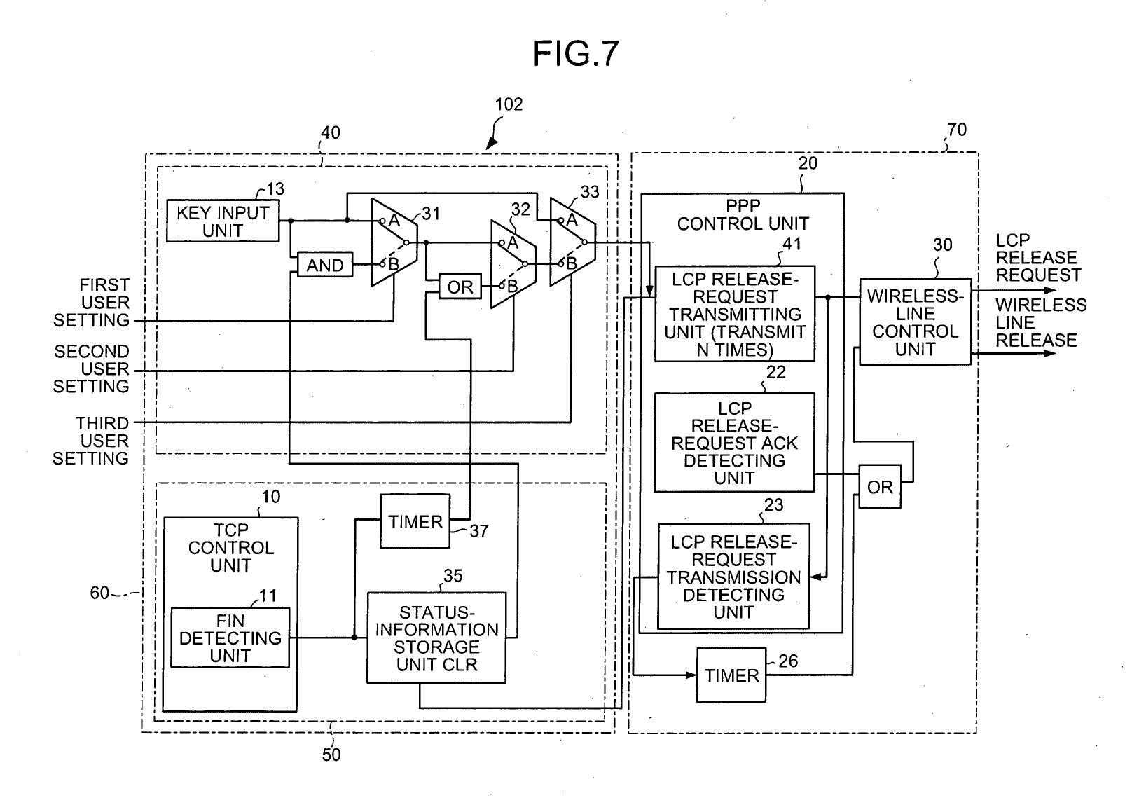

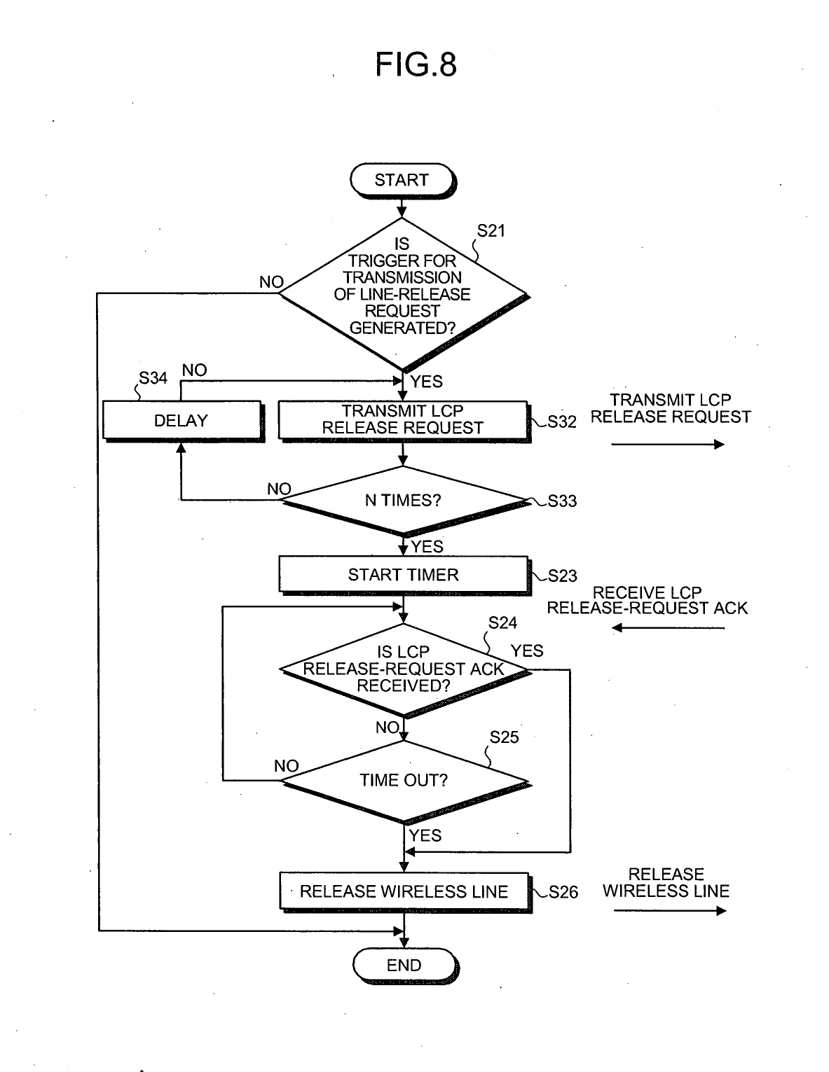

FIG. 7 is a functional block diagram of a mobile terminal device 102 according to a second embodiment of the present invention. FIG. 8 is a flowchart of the operation of the communication control unit when such a signal is received that triggers transmission of the line-release request to the PPP control unit of the mobile terminal device 102. In the mobile terminal device 102, an LCP release-request transmitting unit 41 transmits the LCP release request several times at predetermined time intervals in response to the single trigger generated by the input monitoring unit 60. In other words, as shown in steps S32 to S34 in FIG. 8, if there is the trigger for transmission of the line-release request, the LCP release request is transmitted to the Web server 301 (step S32). If the LCP release request has not yet been transmitted predetermined times (step S33), after a predetermined time (step S34), the process control returns to step S32, and the LCP release request is transmitted again.

According to the second embodiment, it is possible to avoid the case where the LCP release request is not carried from the mobile terminal device 102 to the network (Web server 301) side, by transmitting the LCP release request several times at predetermined intervals. Other configuration is similar to that according to the first embodiment. The LCP release request is transmitted, for example, three times at 5-second intervals based on an assumed situation that a vehicle is passing through a (150-meter long) tunnel. The vehicle running at 60 kilometers per hour requires about nine seconds for having passed through the 150-meter long tunnel. If the signal is transmitted three times at 5-second intervals, it takes 10 seconds to transmit the signal from the first to the last transmissions. Accordingly, it is not happens that the tunnel blocks off all of the release requests.

Upon receiving the LCP release request, the network (Web server 301) side releases the wireless line that is allocated to the mobile terminal device 102. If the first release request is carried to the Web server 301 and a response to the LCP release request from the Web server 301 is not carried to the mobile terminal device 102, the second LCP release request is transmitted from the mobile terminal device 102. However, the second or later LCP release request is treated by the network (Web server 301) side as a request from a terminal with an illegal IP address, and is discarded silently. Therefore, there happens no systematical problem. Such a configuration increases a possibility of the LCP release request having been carried. The case of 3-time transmission with 5-second intervals is one of examples. Not limited to the above number and interval, and any number and interval can be selected.

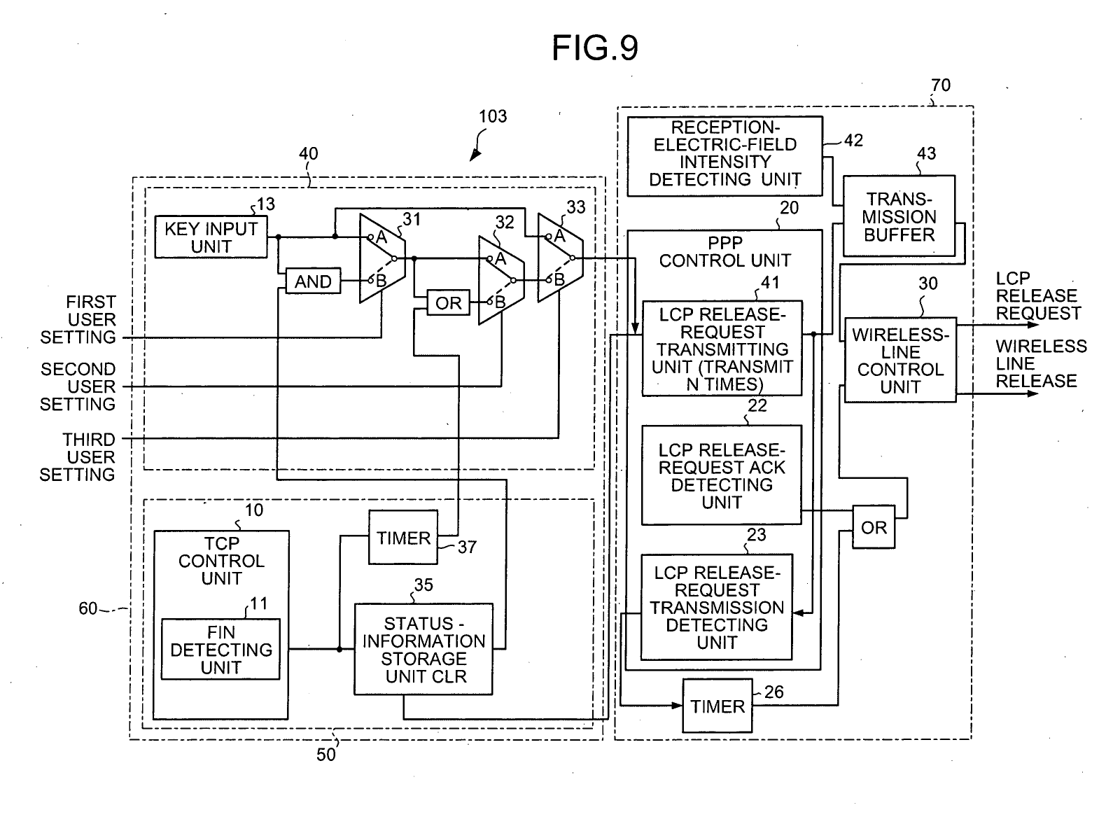

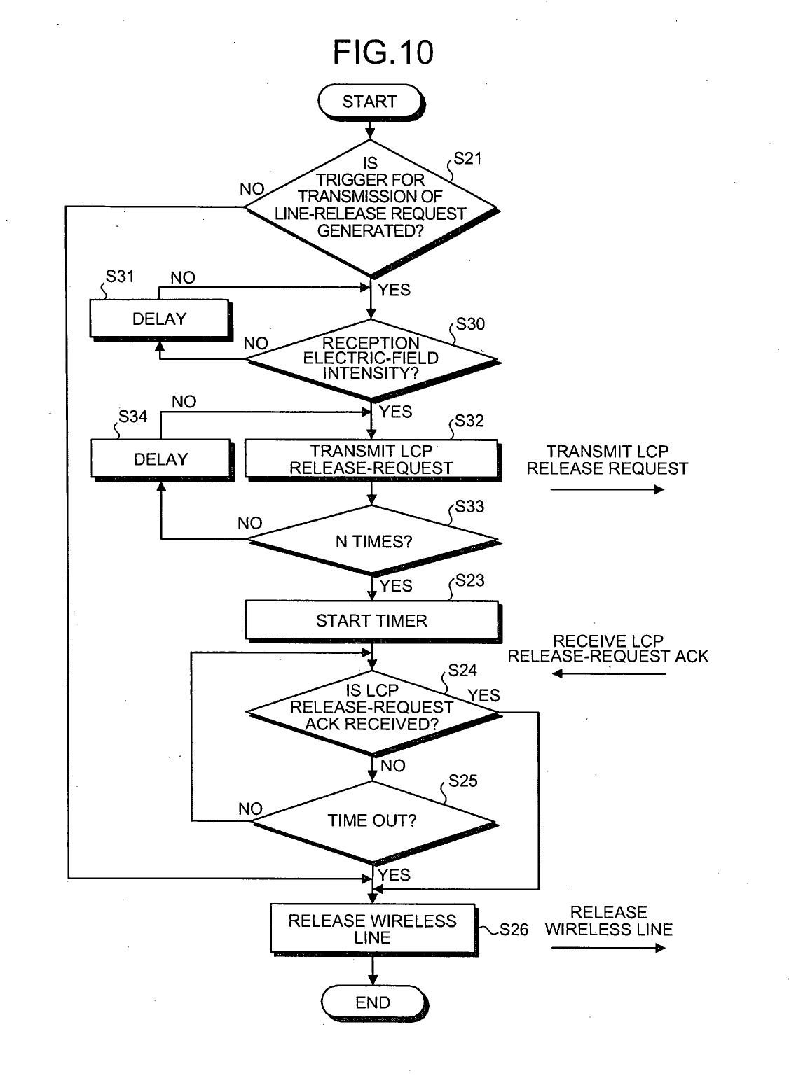

FIG. 9 is a functional block diagram of a mobile terminal device 103 according to a third embodiment of the present invention. FIG. 10 is a flowchart of the operation of the communication control unit when such a signal is received that triggers transmission of the line-release request to the PPP control unit of the mobile terminal device 103. In addition to the configuration according to the second embodiment, the communication control unit 70 of the mobile terminal device 103 includes a reception electric-field intensity detecting unit 42 and a transmission buffer 43. The transmission buffer 43 buffers the line-release request generated by the LCP release-request transmitting unit 21. The reception electric-field intensity detecting unit 42 measures an electric-field intensity of received radio waves (step S30 in FIG. 10), and waits until the electric-field intensity is at or above the threshold (step S31 in FIG. 10). When the electric-field intensity is at or above the threshold, the line-release request buffered by the transmission buffer 43 is transmitted. Other configuration is similar to that according to the second embodiment.

In the mobile terminal device 103 with such a configuration, the reception electric-field intensity detecting unit 42 grasps a surrounding radio wave condition, and transmits, when the radio wave condition turns to be good, the line-release request buffered in the transmission buffer 43. This makes it possible to reduce the unnecessary connection period even in a poor radio wave condition as much as possible, which results in reducing an unnecessary charge.

Although the invention has been described with respect to a specific embodiment for a complete and clear disclosure, the appended claims are not to be thus limited but are to be construed as embodying all modifications and alternative constructions that may occur to one skilled in the art that fairly fall within the basic teaching herein set forth.

What is claimed is:

1. An information processing apparatus configured to be connected to a network system via a line, the information processing apparatus comprising:
a monitoring unit that monitors whether at least one of a line-release signal and a completion signal is received, a line-release signal requesting release of an established line, and a completion signal indicating completion of packet exchange; and
a communication control unit that releases the line when at least one of the line-release signal and the completion signal is received.

2. The information processing apparatus according to claim 1, further comprising a timer unit that counts time since packet exchange is complete, wherein
the monitoring unit releases the line, when a predetermined period has passed since the packet exchange is complete, regardless of whether the line-release signal is received.

3. The information processing apparatus according to claim 1, wherein
the monitoring unit generates a trigger upon receiving at least one of the line-release signal and the completion signal, and
the communication control unit transmits a plurality of line-release requests at predetermined intervals in response to the trigger.

4. The information processing apparatus according to claim 1, wherein
the line is a wireless line, and
the communication control unit measures electric field intensity of a received radio wave, and, when the electric field intensity is equal to or larger than a threshold, releases the line.

5. The information processing apparatus according to claim 4, wherein the communication control unit includes
a buffer that buffers a line-release request; and
a field intensity detecting unit that measures the electric field intensity of the received radio wave, and transmits, when the electric field intensity is equal to or larger than the threshold, the line-release request buffered in the buffer.

6. A computer-readable recording medium that stores therein a computer program for an information processing apparatus configured to be connected to a network system via a line, the computer program causing a computer to execute:
monitoring whether at least one of a line-release signal and a completion signal is received, a line-release signal requesting release of an established line, and a completion signal indicating completion of packet exchange; and
releasing the line upon receipt of at least one of the line-release signal and the completion signal.

7. The computer-readable recording medium according to claim 6, wherein the computer program further causing the computer to execute counting time since packet exchange is complete, and
the releasing includes releasing the line, when a predetermined period has passed since the packet exchange is complete, regardless of whether the line-release signal is received.

8. The computer-readable recording medium according to claim 6, wherein the computer program further causing the computer to execute transmitting a plurality of line-release requests at predetermined intervals when at least one of the line-release signal and the completion signal is received.

9. The computer-readable recording medium according to claim 6, wherein
the line is a wireless line,
the computer program further causing the computer to execute measuring electric field intensity of a received radio wave, and
the releasing includes releasing the line when the electric field intensity is equal to or larger than a threshold.

10. The computer-readable recording medium according to claim 9, wherein the computer program further causing the computer to execute:
buffering a line-release request; and
transmitting the line-release request buffered at the buffering when the electric-field intensity is equal to or larger than the threshold.

11. A line-release method for an information processing apparatus configured to be connected to a network system via a line, the line-release method comprising:
monitoring whether at least one of a line-release signal and a completion signal is received, a line-release signal requesting release of an established line, and a completion signal indicating completion of packet exchange; and
releasing the line upon receipt of at least one of the line-release signal and the completion signal.

12. The line-release method according to claim 11, further comprising counting time since packet exchange is complete, wherein
the releasing includes releasing the line, when a predetermined period has passed since the packet exchange is complete, regardless of whether the line-release signal is received.

13. The line-release method according to claim 11, further comprising transmitting a plurality of line-release requests at predetermined intervals when at least one of the line-release signal and the completion signal is received.

14. The line-release method according to claim 11, further comprising measuring electric field intensity of a received radio wave, wherein
the line is a wireless line, and
the releasing includes releasing the line when the electric field intensity is equal to or larger than a threshold.

15. The line-release method according to claim 14, further comprising:
buffering a line-release request; and
transmitting the line-release request buffered at the buffering when the electric-field intensity is equal to or larger than the threshold.
